(19) United States
(12) Patent Application Publication
(10) Pub. No.: US 2021/0171764 A1
(43) Pub. Date: Jun. 10, 2021

(54) Polyactic Acid and Lignin Composite Thermoplastic for 3D Printing

(71) Applicant: WiSys Technology Foundation, Inc., Madison, WI (US)

(72) Inventors: John Obielodan, Platteville, WI (US); Tsunghsueh Wu, Platteville, WI (US)

(21) Appl. No.: 17/048,319

(22) PCT Filed: Apr. 16, 2019
(86) PCT No.: PCT/US2019/027667

§ 371 Date: Oct. 16, 2020

Related U.S. Application Data
(60) Provisional application No. 62/658,138, filed on Apr. 16, 2018.
(60) Provisional application No. 62/718,025, filed on Aug. 13, 2018.

(51) Int. Cl. C08L 67/04; C08L 97/00; C08K 5/29; B33Y 10/00; B33Y 70/00; B29C 64/118; B29C 64/209; B33Y 30/00; C08K 7/06; C08K 3/04; C08K 5/5419; C08H 7/00

(52) U.S. Cl. CPC C08L 67/04; C08L 2205/08; C08K 5/29; B33Y 10/00; B33Y 70/00; B29C 64/118; B29C 64/209; B33Y 30/00; C08K 7/06; C08K 3/042; C08K 5/5419; C08H 6/00; C08K 2201/003; C08K 2201/004; C08K 2201/005; C08L 97/005

(57) ABSTRACT

A polylactic acid (PLA) composite material includes biodegradable and/or renewable materials such as purified lignin recovered as a byproduct in organosolv processes. The result is a material suitable for additive printing, with improved properties but that is still environmentally friendly. A coupling agent such as silane, diisocyanate crosslinking agent, and reactive extrusion agent may improve the blending of polylactic acid and purified lignin. Additional filler materials such as fibers or their powders may be added to significantly improve the mechanical properties of three-dimensional printed objects.

### STATEMENT REGARDING FEDERALLY SPONSORED RESEARCH OR DEVELOPMENT

### CROSS REFERENCE TO RELATED APPLICATION

This application claims the benefit of U.S. provisional application No. 62/658,138 filed Apr. 16, 2018 and U.S. provisional application No. 62/718,025 filed Aug. 13, 2018, both of which are hereby incorporated by reference.

### BACKGROUND OF THE INVENTION

The present invention relates to a composite thermoplastic material, and in particular, to a composite thermoplastic material to be used in three-dimensional (3D) printing applications.

Polymer three-dimensional printing otherwise known as “additive manufacturing” is a process of making a three-dimensional object by adding layers upon layers of material, such as plastic, metal, concrete, or the like. Fused filament fabrication (FFF) or fused deposition modeling (FDM) techniques heat thermoplastic filament to extrude the molten thermoplastic layer by layer.

In particular, FFF and FDM techniques feed a continuous filament of thermoplastic material typically wound onto a coil through a heated printer extruder head that heats the filament material to its melting point and deposits the molten material onto a growing three-dimensional object. In fused pellets fabrication (FPF) and related techniques, thermoplastic pellets, particles, or powder are heated instead of filaments and extruded onto the growing three-dimensional object. The molten material is extruded directly on a deposition plate or substrate layer-by-layer to form the three-dimensional object. The printer extruder head and/or deposition plate move in three dimensions under computer control to define the footprint of the printed shape and to provide stacked horizontal layers defining the three-dimensional object as understood in the art.

Many thermoplastic materials are available for three-dimensional printing, each having their own trade-offs between strength, surface finish and post processing, thermal properties, and biodegradability. Common thermoplastic filaments or pellets used in 3D printing include acrylonitrile butadiene styrene (ABS), polylactic acid (PLA), polycarbonate (PC), polyamide (PA), polystyrene (PS), lignin, rubber, granular polyether ether ketone (PEEK), and the like known in the art.

ABS is a petroleum derived plastic that has high strength, flexibility and durability, but is prone to warping and is not biodegradable. PLA is made of organic material derived from renewable sources such as corn starch, tapioca roots, chips or starch, or sugarcane. It is easier to print with, provides greater detailed printing, and is more environmentally friendly than ABS. However, PLA has been found to be brittle and thermally instable.

### SUMMARY OF THE INVENTION

The present invention provides a polylactic acid (PLA) composite material that includes biodegradable and/or renewable materials such as purified lignin recovered as a byproduct in organosolv processes. The result is a material suitable for additive printing, with improved properties but that is still environmentally friendly. The present inventors have determined that PLA blended with purified lignin has advantages over preexisting filaments or pellet material, including reduced material cost, biodegradable properties, adjustable mechanical properties, improved thermal stability, heat shielding, flame retardation, and ultraviolet radiation shielding in 3D printed parts.

Many polymer pairs are thermodynamically incompatible because of coarse phase morphology and poor interfacial adhesion. For example, lignins are known to self-aggregate because they are irregular polymers made of substituted phenol rings, phenolics, and aliphatic hydroxyl groups. Self-aggregation causes reduced surface interactions with PLA. This effect becomes more severe at higher lignin loadings. Typical chemical modification techniques such as acetylation are used to provide higher loading of polymer pairs but typically involve expensive and toxic solvents not ideal for industrial scale processes. The present inventors have found that using a coupling agent such as silane coupling agent improves the blending of polylactic acid and purified lignin.

One embodiment of the present invention provides a composition of thermoplastic material for three-dimensional printing including purified polylactic acid and purified lignin blended in the purified polylactic acid where the amount of purified lignin may be at least 30 weight percent. The purified lignin may be at least 40 weight percent.

It is thus a feature of at least one embodiment of the present invention to provide improved blending of polylactic acid with reinforcement materials such as lignin where high loading of lignin within the polylactic acid is required for filament extrusion.

The composition may further include a compatibilizer. The compatibilizer may be a silane coupling agent.

It is thus a feature of at least one embodiment of the present invention to improve loading of lignin within polylactic acid thus improving the toughness of the composite material.

The composition may further include carbon fibers dissolved in the purified polylactic acid. The amount of carbon fibers may be between 1 and 10 weight percent.

It is thus a feature of at least one embodiment of the present invention to produce a composite polymer with high strength (maximum stress that material can withstand before breaking), stiffness (resistance to deformation), toughness (ability to absorb energy and deform without fracturing), and ultraviolet light resistance as compared to neat PLA or acrylonitrile butadiene styrene (ABS).

The composition may be in the form of a pellet, particle, or powder. The pellet, particle, or powder may have a diameter of less than 4.0 mm. The pellet, particle, or powder may have a diameter less than 3.0 mm. The pellet, particle or powder may have a diameter less than 2.0 mm.

It is thus a feature of at least one embodiment of the present invention to produce composite thermoplastic polymer materials with various shapes and sizes usable with pre-existing three-dimensional printing techniques.

The composition may be in the form of a filament. The filament may have a diameter of less than 3.0 mm. The filament may have a diameter of less than 2.0 mm. The filament may have a tensile strength of at least 20 MPa.

It is thus a feature of at least one embodiment of the present invention to produce a composite polymer that has good flowability and printability (based on factors such as oozing, warping, clogging, etc.) for filament extrusion.

The purified lignin may be 85% to 95% acid soluble lignin and acid insoluble lignin.

It is thus a feature of at least one embodiment of the present invention to form a composite polymer using an abundant natural polymer and inexpensive waste product.

The composition may be black or brown in color.

It is thus a feature of at least one embodiment of the present invention to produce a composite polymer with good thermal stability and UV light resistance.

The composition may be composed of renewable materials.

It is thus a feature of at least one embodiment of the present invention to provide an environmentally benign polymer that is biodegradable and non-toxic to the environment.

The present invention also provides a manufacturing process for producing a polylactic acid and lignin composite thermoplastic material for use in three-dimensional printing applications.

The present invention provides a method for producing a composite thermoplastic filament for three-dimensional printing including producing a composition of thermoplastic material comprising an amount of purified polylactic acid and an amount of purified lignin blended in the purified polylactic acid and wherein the purified lignin is at least 30 weight percent; heating the composition to liquefy the composition; and extruding the liquefied composition from an extruder nozzle of a three-dimensional printer to produce a three dimensional object.

It is thus a feature of at least one embodiment of the present invention to produce a homogenous and flowable composite thermal polymer for three-dimensional printing which prevents clogging.

The purified lignin may be produced by an organosolv process.

It is thus a feature of at least one embodiment of the present invention to form high purity lignins with lower sugar and ash contents than is used with conventional pulping techniques such as kraft, sulfite, and soda techniques.

These particular objects and advantages may apply to only some embodiments falling within the claims and thus do not define the scope of the invention.

### BRIEF DESCRIPTION OF THE DRAWINGS

FIG. 1 is a flow chart showing a method of using a polylactic acid and purified lignin composite material in accordance with the present invention for use with a three-dimensional printer;

FIG. 2 is a schematic representation of a bio-refinery plant for producing a lignin byproduct used in the manufacturing process of FIG. 1;

FIG. 3 is a flow chart of a first blending approach for mixing polylactic acid and purified lignin while both in solid form;

FIG. 4 is a flow chart of a second blending approach for mixing polylactic acid and purified lignin while both in liquid form;

FIG. 5 is a bar graph showing tensile strengths of polylactic acid and lignin composite material samples compared to those made with acrylonitrile butadiene styrene (ABS);

FIG. 6 is a bar graph showing tensile stiffness of polylactic acid and lignin composite material samples compared to those made with ABS; and

FIG. 7 is a bar graph showing percent elongation of polylactic acid/lignin composite material samples compared to those made with ABS.

### DETAILED DESCRIPTION OF THE PREFERRED EMBODIMENT

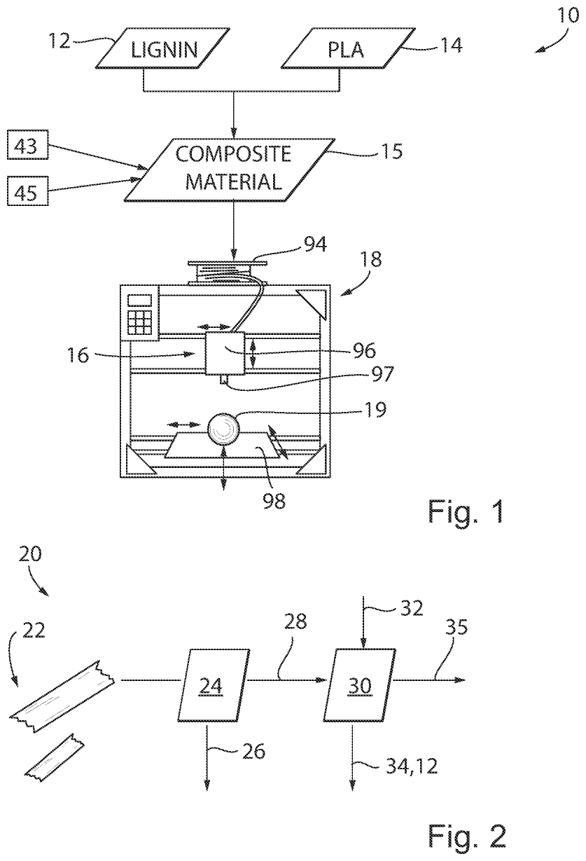

Referring to FIG. 1, a three-dimensional (3D) printing system 10 may include combining purified lignin 12, for example, produced in an organosolv process as will be further described below with respect to FIG. 2, with polylactic acid 14 to produce a composite thermoplastic material 15. The composite thermoplastic material 15 may take the form of filaments, pellets, particles, powder and the like which may then be used by a printer extruder 16 of a three-dimensional printer 18 for forming a three-dimensional printed object 19.

In paper making processes, the “organosolv process” utilizes an organic solvent, such as acetone, methanol, ethanol, butanol, ethylene glycol, formic acid, propanol, pentanol and acetic acid, to solubilize lignin and hemicellulose from plant fiber feedstock, such as chipped wood. Lignin is a byproduct dissolved from the plant fiber, producing a highly lignin-solvent mixture that can be reused for fuel ethanol production. Pure lignin can be recovered from the organosolv process by diluting the lignin-solvent mixture with acidified water. The pure lignin precipitates into spherical aggregates that can be collected by filtration or centrifugation and can be used for other processes.

Referring to FIG. 2, the purified lignin 12 may be produced in a lignin-solvent bio refinery 20 that can accept any kind of lignocellulosic biomass or plant fiber 22, for example, from hardwood or softwood trees, bioenergy crops such as Miscanthus or switch grass, agricultural refuse such as sugar cane, corn stover, or wheat straw, and from other sources such as flax, jute, switch grass, and kenaf, among others. The cellulose plant fiber materials 22 may be chipped, chopped and/or ground to an appropriate size and received by a pre-treater 24 of the lignin-solvent bio refinery 20 to remove hemicellulose 26 from the biomass or plant fiber 22 according to techniques well known in the art for use with various types of plant fiber 22, such as by utilizing steam or dilute acid. Hemicelluloses are easy to remove via the pre-treater 24 and their absence simplifies the rest of the process and eliminates the complicated downstream separation of hemicellulose and cellulose sugars. The hemicellulose 26 can then be taken from the pre-treater 24 as a sugar mixture that can be utilized as a feedstock in other processes, such as a fermentation process, to form various products including ketones such as acetone, alcohols such as ethanol, n-butanol, methyl butanol, and isoprene, which can be re-utilized by the bio refinery 20.

The remaining lignocellulosic material 28 is also removed from the pre-treater 24 and received by an organosolv pulper 30 which, for example, can employ the Alcell® process. The organosolv pulper 30 receives an organic solvent 32 to extract the lignin from the cellulose of the lignocellulosic material 28, producing a first product stream of a “black liquor” 34 comprised of the aqueous solvent, organic solvent, and lignin that is used to form a lignin-solvent mixture, as well as a second product stream comprising the purified cellulose 35 To produce the purified cellulose 35 and the black liquor 34 product streams, the pulper 30 is operated at conditions most conducive to the separation of the lignin from the cellulose. These conditions may vary based on the particular solvent 32 utilized in the pulper 30 but preferably are a solvent/water concentration range of 30 to 70 percent by weight or volume in water, an acid addition of a suitable acid of 0.1 to 5 percent based on the weight of oven-dry biomass, temperatures of 150 to 250 degrees C., cooking times of 0.5 to 8 hours, and total liquid to biomass ratio of 3-10:1 (total liquid:oven-dry biomass).

The resulting purified cellulose 35 stream may be employed in a variety of processes, such as in a conventional papermaking process and the composite thermoplastic filament or pellet material productions as further described below.

Optionally a grafting step may be performed by adding carboxylic acids which contain multiple carboxylic acid functional groups per molecule such as lactic acid, citric acid, butanetetracarboxylic acid, maleic acids and others before the lignin extraction to simultaneously produce ester functional groups and eliminate hydroxyl groups on organosolved lignin to enhance surface adhesion of lignin 12 and polylactic acid 14 by imparting a variety of functional groups to the lignin polymer.

The process of producing purified lignin 12 from an organosolv process is described in U.S. Pat. No. 8,211,189 entitled “Lignin-solvent fuel and method and apparatus for making same” and U.S. Pat. No. 8,465,559 entitled “Lignin-solvent fuel and method and apparatus for making same,” each assigned to the present applicant and each of which are hereby incorporated by reference.

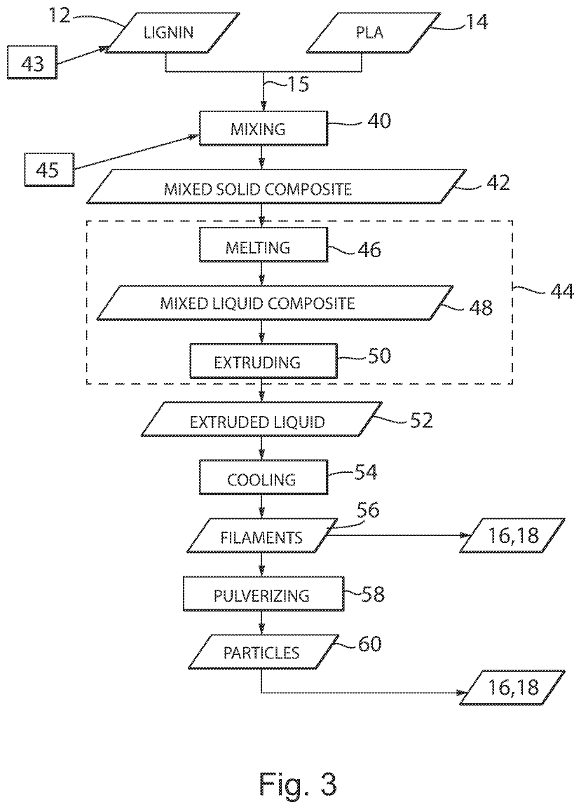

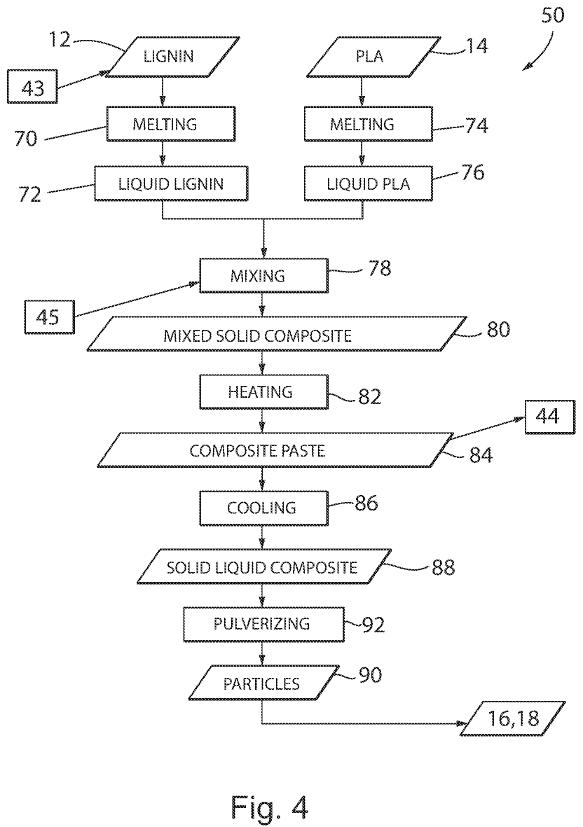

Referring to FIGS. 3 and 4, the purified lignin 12 produced by the organosolv process described above with respect to FIG. 2 may be combined with purified polylactic acid 14 to produce the composite thermoplastic material 15.

The purified lignin 12 may take the form of a solid block. A powder form of the purified lignin 12 may be then formed using a ball mill to pound the solid blocks into smaller forms including pellets, particles, or a powder. The milled forms of purified lignin 12 may have a desired particle diameter less than 4.0 mm or less than 3.6 mm diameter.

The lignin purity may be 85-95% (acid soluble lignin+acid insoluble lignin, measured by TAPPI method T222-0m02). The lignin may have over 80% purity, 2-3% phenolic content, 1%-1.5% ash. Lignin is composed mainly of syringyl (S) and guaiacyl (G) units with minor amount of p-hydroxyphenyl (H). The S:G:H ratios may be 10% to 40% of S, 50% to 80% of G and 0% to 20% of H. Elemental analysis may show 59.3% carbon, 6.0 hydrogen, 32.2% oxygen, 1.5% nitrogen, and 0.9% sulfur. Purified lignin 12 suitable for the present invention can be purchased widely from a variety of commercial sources.

The purified polylactic acid 14 may take the form of pellets, particles, or powder. The purified polylactic acid 14 may have a desired particle diameter less than 4.0 mm and less than 3.6 mm diameter. The powder form of the purified polylactic acid 14 may be formed using a cryogenic grinding to pound bigger pellets into smaller diameter powder. In one embodiment the pure polylactic acid 14 is a about 1.75 mm diameter pulverized powder that may be white in color. The pure polylactic acid 14 may have an extrusion temperature of 180 to 200 degrees Celsius and a capability of extruding filaments at about 1.50-3.0 mm diameter. The purified polylactic acid 14 may be purchased commercially from, for example, Filabot LLC sold under the trade name “PLA 4043D”.

Referring to FIG. 3, in a first embodiment of the combining process, the production of the composite thermoplastic material 15 may generally include a first step in which the purified lignin 12 and purified polylactic acid 14 are mixed as solid forms as indicated by process step 40 to form a mixed solid composite 42.

It may be desired that the purified lignin 12 and the purified polylactic acid 14 may take a same or similar solid form or shape and a same or similar particle size to promote homogeneity of the mixed solid composite 42. For example, both the purified lignin 12 and purified polylactic acid 14 may be pellets, particles, or a powder with similar sized particles. In one nonlimiting example, both the purified lignin 12 and purified polylactic acid 14 are about 1.75 mm in diameter.

The relative amounts of purified lignin 12 and purified polylactic acid 14 may include desired weight ratios of each component. For example, 20-50 wt % and at least 20 wt %, at least 30 wt %, at least 40 wt %, and at least 50 wt % purified lignin 12 loading in purified polylactic acid 14 may be used in the mixed solid composite 42. The different weight ratios may produce desired material attributes as further described below in the examples. The greater content of lignin 12 in the mixed solid composite 42 represents a lower percentage of high priced purified polylactic acid 14 and therefore a lower filament cost.

Compatibilizers 43 may be added to lignin to improve surface interaction with PLA and strength. Compatibilizers 43 may be coupling agents such as silanes and 3-aminopropyl-triethoxysilane (APS), or crosslinkers such as aromatic or aliphatic polyisocyanates namely diphenylmethane diisocyanate, hexamethylene diisocyanate, and others possessing bifunctional groups which may be used to manipulate interface properties of lignin and polylactic acid thus facilitating their molecular interactions. In the presence of water, silanes are hydrolyzed to silanol groups which are reactive towards hydroxyl groups on lignin. Heating, for example 110° C. for 2 hours, can drive dehydration reactions at the absorption sites between silanols and lignin hydroxyl groups forming Si—O—C bonds. In addition to the removal of hydrophilic groups on lignin, the amino groups on the covalently bonded APS will provide hydrogen bonding to polylactic acid and improve their interfacial interaction. The diisocyanate is reactive to hydroxyl groups on lignin and the removal of hydroxyl group enhances the interaction between lignin and PLA. Compatibilizer 43 may also be high temperature bonding reagents, which allow the PLA and lignin to bond together at high temperature, for example, between 160 and 180 degrees celcius during extrusion or high temperature mixing. These high temperature bonding reagents require both a radical initiator (such as 2,5-bis(tert-butylperoxy)-2,5 dimethylhexane, dicumyl peroxide, di-tert-butyl peroxide and dibenzoyl peroxide) and an anhydride with at least one unsaturated bond such as maleic anhydride (MA) and acrylic anhydride to work. In one embodiment a 2% by weight of MA was used by varying the initiator concentration between 0 to 0.5% by weight. The radical initiator can induce free radical formation in PLA molecules at a carbon, which can react with alkene in maleic anhydride. The anhydride functional group can form ester bonding with the hydroxyl functional groups on lignin.

Short filler fibers or powders 45 may be added to reinforce the composite material thereby significantly increasing tensile strength and stiffness at high lignin concentration. For example, the short filler fibers powders 45 may be carbon fibers, carbon nanotubes, talc, xylite fibers, and graphene flakes added at between 1 wt % and 10 wt %.

Once the purified lignin 12 or lignin 12 optionally pre-treated with compatibilizer 43, the purified polylactic acid 14, and optionally short filler fibers or powders 45 are mixed to form the mixed solid composite 42, the mixed solid composite 42 is introduced or fed into a filament extruder 44 which is able to perform melt mixing and extruding steps. The filament extruder 44 may be integrated with the three-dimensional printer 18 or may be a separate component.

The filament extruder 44 may melt the mixed solid composite 42 as indicated by process step 46 using a heater of the filament extruder 44. The mixed solid composite 42 is then melted into a mixed liquid composite 48 which is capable of being extruded from the filament extruder 44 as indicated by process step 50.

After the extrudate 52 exits the filament extruder 44 it is allowed to cool as indicated by process step 54 to form solid filaments 56. The filaments 56 may be used by the printer extruder 16 of the three-dimensional printer 18.

In an alternative embodiment, the solid filaments 56 may be further pulverized as indicated by process step 58 to form solid pellets 60 which may then be used by the printer extruder 16 of the three-dimensional printer 18 implementing fused pellets fabrication (FPF). It is also understood that the solid pellets 60 may be particles or a powder.

Referring to FIG. 4, in an alternative embodiment of the combining process, the purified lignin 12 and purified polylactic acid 14 may be mixed in liquid form as opposed to being mixed in solid form as previously described in FIG. 3.

In this respect the purified lignin 12 or lignin 12 optionally pre-treated with compatibilizer 43 in solid form may be melted, as indicated by process step 70, to form a molten lignin 72. Similarly, purified polylactic acid 14 in the form of solid particles may be melted, as indicated by process step 74, to form molten polylactic acid 76.

Pre-measured amounts of each molten material 72, 76 are mixed together, as indicated by mixing step 78. The mixed liquid composite 80 may include desired weight ratios of each component, as previously described above with respect to FIG. 3. Fibers or powders 45 may also be added to the mixed liquid composite 80 to achieve similar results with respect to FIG. 3.

The mixed liquid composite 80 may be heated as indicated by process step 82 at a desired temperature for a predetermined amount of time to facilitate stirring of the mixed liquid composite 80 into a homogeneous viscous paste 84. For example, the mixed liquid composite 80 may be mixed for about 10-15 minutes at 35 rpm rotating speed at a mixing temperature of 165 to 190 degrees Celsius. The viscous paste 84 may then be allowed to cool and solidify, as indicated by process step 86.

The solid liquid composite 88 may then be pulverized into smaller pellets 90 as indicated by process step 92. The pellets 90 may then be used by the printer extruder 16 of the three-dimensional printer 18 implementing fused pellets fabrication (FPF). It is also understood that the pellets 90 may also be particles or a powder.

It is also understood that in an alternative embodiment the composite paste 84 may be extruded from a filament extruder 44 to form filaments 56 that may be used by the printer extruder 16 of the three-dimensional printer 18 as previously described above with respect to FIG. 3.

Referring again to FIG. 1, the composite thermoplastic material 15 may be used by the printer extruder 16 in the form of filaments 56 or in the form of pellets 60, 90 as source material. When used in the form of filaments 56, the fibers may have a diameter of about 1.25-3.0 mm and less than 3.0 mm and less than 2.0 mm and about 1.75 mm and about 2.85 mm. The filaments 56 may have a tensile strength of at least 20 MPa and at least 30 MPa and at least 50 MPa and at least 60 MPa. The filaments 56 are optionally wound around a spool 94 for dispensing the filament 56 into the printer extruder 16. The filament 56 may be black or brown in color because of the natural color of the lignin 12 and/or fiber or powder 45. When used in the form of pellets 60, 90, the pellets may have a size of about 1.5 mm to 4 mm and less than 4 mm and less than 2 mm and about 1.75 mm and about 3.6 mm.

The composite thermoplastic material 15 is fed into the printer extruder 16 which melts the composite thermoplastic material 15 using an internal heater of an extruder head 96 and extrudes the molten material out of a nozzle 97 onto a three-dimensional printer deposition plate 98 supporting the growing three-dimensional object 19.

The composite thermoplastic material 15 may be used to print three-dimensional objects, as understood in the art with respect to fused filament fabrication (FFF), fused deposition modeling (FDM), or fused pellets fabrication (FPF) techniques.

The three-dimensional printer extruder parameters, such as extrusion temperature, may be modified according to the blend of the composite thermoplastic material 15. For example, three-dimensional printer extrusion temperature range of 170-210 degrees Celsius may be used for 10-50 wt % and at least 10 wt %, and at least 20 wt %, and at least 30 wt % lignin loading in polylactic acid. Other three-dimensional print parameters may be adjusted based upon the composite thermoplastic material 15 blend including extrusion speed, printer nozzle diameter, nozzle temperature, substrate temperature, deposition speed, layer thickness, hatch pattern, and hatch spacing.

The following examples are offered for illustrative purposes only and are not intended to limit the scope of the present invention in any way. Various modifications of the invention in addition to those shown and described herein will become apparent to those skilled in the art from the foregoing description and the following examples and fall within the scope of the appended claims.

### EXAMPLE 1

In preliminary solubility testing, a solubility of 2-grams of dried lignin powder in mixtures of acetone in water was similar to the results of switchgrass lignin and pine lignin solubility in acetone in water mixtures.

### EXAMPLE 2

Purified lignin derived by the organosolv process described above with respect to FIG. 2, was compared to lignin produced by kraft process (pulping with sodium sulfite and sodium hydroxide) and soda process (pulping in sodium hydroxide solution). It was found that recovery of lignin using the kraft process and soda process was limited. The organosolv-based lignin produced pure and ungraded lignin with a narrow molecular weight distribution.

Attempts to blend kraft lignin in polylactic acid did not succeed beyond 5 wt % kraft lignin (lignin derived from the kraft process) loading in polylactic acid because of kraft lignin's immiscibility with polylactic acid and lack of flowability making it difficult to extrude into small diameter filaments at a higher weight percent.

### EXAMPLE 3

In an acetone fractionation technique, one gram of dried purified lignin was mixed with 10 mL of 60% (v/v) acetone in water in a first step the mixture was stirred for 10 minutes. The first undissolved solid (INS) was collected without any rinsing and dried in an oven at 110° C. Then the first filtrate was diluted to 40% (v/v) acetone in water by adding water to form the second undissolved solid (PREC) in a second step. The PREC solid was filtered and dried in the oven at 110° C. PREC. The second filtrate was collected and the soluble solid (SOL) was obtained in a third step.

Purified lignin derived from wheat straw versus maple wood were compared using the acetone fractionation technique. The yields of organosolv-based lignin from wheat straw in this fractionation technique were 10% insoluble fraction (INS) in the first step, 70% insoluble fraction (PREC) in the second step, and 20% soluble fraction (SOL) in the third step. The yields of organosolv-based lignin from maple wood in this fractionation technique were 70% insoluble fraction (INS) in the first step, 2.3% insoluble fraction (PREC) in the second step, and 22% soluble fraction (SOL) in the third step. Compared to lignin from wheat straw, a majority of lignin from maple wood was INS lignin which contains higher molar mass and minimum content of phenolic hydroxyl group.

### EXAMPLE 4

In initial mechanical testing and scanning electron microscope (SEM) fractographic analysis on polylactic acid and lignin composite thermoplastic material, the SEM fractographics of tensile specimens show evidence of well-bonded structures. There was no evidence of rupturing that could be indicative of poor interlayer or intralayer material bonding. And the polylactic acid and lignin composite was found to be tougher than pure polylactic acid.

### EXAMPLE 5

In initial tensile strength testing, it was found that increasing mass fractions of unmodified organosolv-based lignin resulted in decreased tensile strength. At 25 wt % the polylactic acid and lignin composite thermoplastic material had a tensile strength of over 30 MPa. At 30 wt % to 40 wt % the polylactic acid and lignin composite thermoplastic material had a tensile strength of over 20 MPa.

### EXAMPLE 6

Lignin displays fluorescence as dark green color under UV light. The observed fluorescence from polylactic acid and lignin composite thermoplastic material and composite filament was uniform, an indication of well-blended lignin in polylactic acid according to the methods described above. In contrast, commercial polylactic acid does not contain any lignin as the extracted product is a white powder, insoluble in chloroform, and displays no florescence.

### EXAMPLE 7

Extraction conditions were tested to obtain soluble lignin solution. Various temperatures (100, 110, 150 and 175 degrees C.), acid concentration (1 v/v %, 8.3 v/v % and 10 v/v %) and the liquid-to-solid ratio (5, 10, 12, and 15) were performed for lignin extraction. The best conditions for extraction were found to be 175 degrees C., 8.3 v/v % acid, and 15 liquid-to-solid ratio in 50 v/v % ethanol solution for a higher yield of extracted lignin. Lignin may be recovered from the solution by precipitating the solution at pH 2 and separating the lignin from the solution by filtration.

Lignin based filaments with 10 w/w % lignin in polylactic acid was produced having the following properties: tensile strength of 46.3 MPa; stiffness of 3.3 GPa; and % elongation of 7.0.

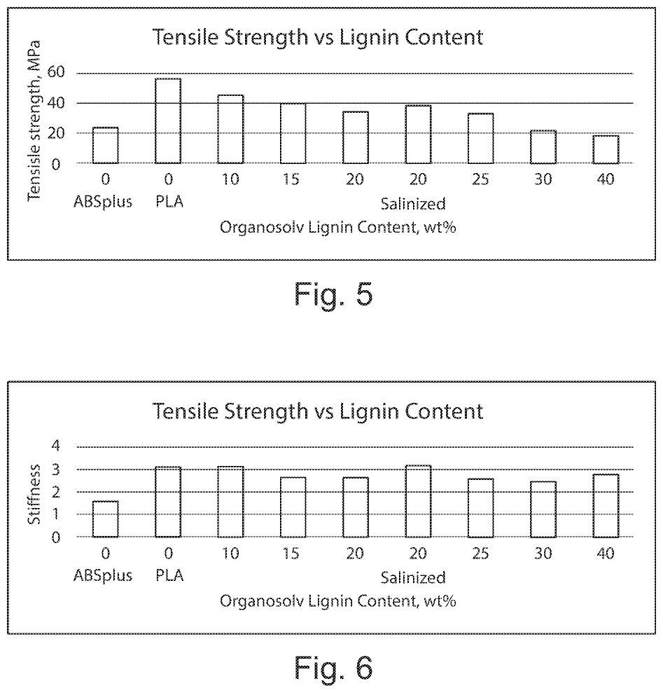

Referring to FIGS. 5 through 7 results of mechanical testing on polylactic acid and lignin composite thermoplastic material samples fabricated on a three-dimensional printer are shown.

FIG. 5 indicates tensile strengths (MPa) of polylactic acid and lignin composite samples compared to acrylonitrile butadiene styrene (ABS). Polylactic acid and lignin composite samples showed higher tensile strengths at 10 to 25 wt % pure lignin compared to ABS.

FIG. 6 indicates tensile stiffness (GPa) of polylactic acid and lignin composite samples compared to ABS. Polylactic acid and lignin composite samples showed higher stiffness at 10 to 40 wt % pure lignin compared to ABS.

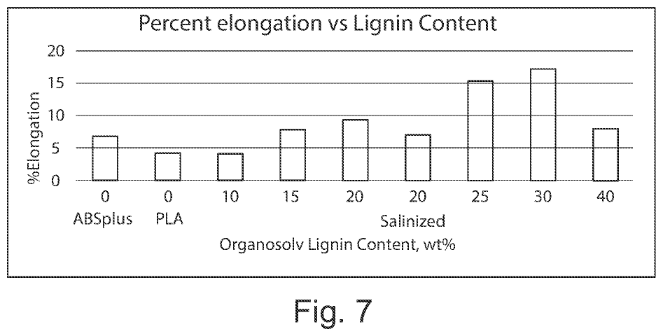

FIG. 7 indicates percent elongation of polylactic acid and lignin composite samples compared to ABS. Polylactic acid and lignin composite samples showed greater elongation at 15 to 40 wt % pure lignin compared to ABS.

Renewable materials are plant-based materials that can be replenished within a period of 10 years or less.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A composition of thermoplastic material for use with plastic manufacturing processes comprising:
purified polylactic acid; and
purified lignin blended in the purified polylactic acid;
wherein the purified lignin is at least 20 weight percent.

2. The composition of claim 1 wherein the purified lignin is between 20 and 50 weight percent.

3. The composition of claim 1 further comprising a compatibilizer.

4. The composition of claim 3 wherein the compatibilizer is at least one of a silane coupling agent, diisocyanate crosslinking agent, and reactive extrusion reagent.

5. The composition of claim 1 further comprising fibers and powders selected from a group consisting of carbon fibers, talc, xylite fibers, and graphene flakes dissolved in the purified polylactic acid.

6. The composition of claim 5 wherein the amount of fibers and powders is between 1 and 10 weight percent.

7. The composition of claim 1 wherein the composition is at least one of a pellet, particle, and powder.

8. The composition of claim 7 wherein the at least one of a pellet, particle, and powder has a diameter of less than 3.0 mm.

9. The composition of claim 8 wherein the at least one of a pellet, particle, and powder has a diameter of less than 2.0 mm.

10. The composition of claim 1 wherein the composition is a filament.

11. The composition of claim 10 wherein the filament has a diameter of less than 3.0 mm.

12. The composition of claim 11 wherein the filament has a diameter less than 2.0 mm.

13. The composition of claim 10 wherein the filament has a tensile strength of at least_20 MPa.

14. The composition of claim 1 wherein the purified lignin may be 85% to 95% acid soluble lignin and acid insoluble lignin.

15. The composition of claim 1 wherein the composition is black in color.

16. The composition of claim 1 wherein the composition is composed of renewable materials.

17. A method for producing a composite thermoplastic filament for a plastic manufacturing processes comprising:
producing a composition of thermoplastic material comprising an amount of purified polylactic acid and an amount of purified lignin blended in the purified polylactic acid wherein the purified lignin is at least 20 weight percent;
heating the composition of thermoplastic material to liquefy the composition of thermoplastic material; and
forming the liquefied composition of thermoplastic material to produce a three-dimensional object when cooled.

18. The method of claim 17 wherein the purified lignin is produced by an organosolv process.

19. The method of claim 17 further including a preliminary step of extracting the purified lignin from biological material using an organosolv pulper and adding carboxylic acid before the lignin extraction to simultaneously produce ester functional groups and eliminate hydroxyl groups on organosolved lignin to produce enhance surface adhesion of the purified lignin and purified polylactic acid.

20. The method of claim 17 wherein the step of forming the liquified composition of thermoplastic material comprises extruding the liquified composition of thermoplastic material through an extruder nozzle of a three dimension printer.
